(19) United States
(12) Patent Application Publication
(10) Pub. No.: US 2026/0104692 A1
(43) Pub. Date: Apr. 16, 2026

(54) DISPLAY METHOD, TERMINAL DEVICE, AND STORAGE MEDIUM

(71) Applicants: KABUSHIKI KAISHA TOSHIBA, Kawasaki-shi (JP); TOSHIBA DIGITAL SOLUTIONS CORPORATION, Kawasaki-shi (JP)

(72) Inventors: Mayumi MACHINO, Kawasaki (JP); Tatsuya ITAGAKI, Yokohama (JP); Akira NINOHEI, Kawaguchi (JP); Satoru ASAGIRI, Yokohama (JP); Kentaro UMEKAWA, Mitaka (JP); Kohsuke TAKAI, Yokohama (JP); Yoshiyuki OOISHI, Yokohama (JP)

(73) Assignees: KABUSHIKI KAISHA TOSHIBA, Kawasaki-shi (JP); TOSHIBA DIGITAL SOLUTIONS CORPORATION, Kawasaki-shi (JP)

(21) Appl. No.: 19/353,741

(22) Filed: Oct. 9, 2025

(30) Foreign Application Priority Data
Oct. 11, 2024 (JP) 2024-179412

(51) Int. Cl. G05B 19/418; G06F 3/04817; G06F 3/04842

(52) U.S. Cl. CPC G05B 19/4184; G06F 3/04817; G06F 3/04842

(57) ABSTRACT

A display method according to an embodiment is a method of displaying, on a screen of a terminal device, data related to equipment supplying components to a workpiece. The display method includes displaying a first user interface configured to accept a selection of an equipment and a selection of a period. The display method includes displaying a second user interface including an error rate and a supplied component count related to a first equipment selected in the first user interface for a first period selected in the first user interface.

### CROSS-REFERENCE TO RELATED APPLICATIONS

This application is based upon and claims the benefit of priority from Japanese Patent Application No. 2024-179412, filed on Oct. 11, 2024; the entire contents of which are incorporated herein by reference.

### FIELD

Embodiments of the invention relate generally to a display method, a terminal device, and a storage medium.

### BACKGROUND

Various data is collected by production equipment. There is a need for technology that can obtain information related to the production equipment based on the data, and display the information to a user.

### BRIEF DESCRIPTION OF THE DRAWINGS

FIG. 1 is a schematic view showing an application example of an embodiment;

FIG. 2 is a schematic view illustrating a first user interface displayed by a display method according to the embodiment;

FIG. 3 is a schematic view illustrating a second user interface displayed by the display method according to the embodiment;

FIG. 4 is a schematic view illustrating a third user interface displayed by the display method according to the embodiment;

FIG. 5 is a block diagram schematically showing functions of a server;

FIG. 6 is a block diagram schematically showing functions of a terminal device;

FIG. 7 is a table illustrating rules for converting logs;

FIG. 8 is a table illustrating rules for converting logs;

FIG. 9 is a table illustrating rules for converting logs;

FIG. 10 is a table illustrating data registered in a common database;

FIG. 11 is a table illustrating data included in logs;

FIG. 12 is a table illustrating data included in logs;

FIG. 13 is a table illustrating data registered in the common database;

FIG. 14 is a flowchart showing a display method according to the embodiment;

FIG. 15 is a schematic view showing an example; and

FIG. 16 is a schematic view illustrating a hardware configuration.

### DETAILED DESCRIPTION

A display method according to an embodiment is a method of displaying, on a screen of a terminal device, data related to equipment supplying components to a workpiece. The display method includes displaying a first user interface configured to accept a selection of an equipment and a selection of a period. The display method includes displaying a second user interface including an error rate and a supplied component count related to a first equipment selected in the first user interface for a first period selected in the first user interface.

Embodiments of the invention will now be described with reference to the drawings. In the drawings and the specification of the application, components similar to those described thereinabove are marked with like reference numerals, and a detailed description is omitted as appropriate.

A production line for producing a product includes various production equipment. Workpieces are processed by each production equipment. A workpiece is an object processed by the equipment, and is, for example, a partly-finished product, a part, or a finished product. The production equipment performs various processing of workpieces such as patterning, film formation, coating, printing, cleaning, heating, cooling, drying, wetting, part mounting, inspection, etc. Hereinbelow, production equipment that performs prescribed processing of a workpiece is referred to as simply “equipment”.

In particular, a production line uses many equipment that supply prescribed components to workpieces. “Component” refers to a real object necessary to produce a product. For example, when the equipment is a solder supply device, the component that is supplied is solder. When the equipment is a dispenser or a coater, the equipment supplies an adhesive, a lubricant, a cleaning liquid, a coating material, etc., to the workpiece. When the equipment is a mounter, the component that is supplied is a part. When the equipment supplies a prescribed component to a workpiece, the “processing” of the workpiece refers to the supply of the component.

Various data are collected by each equipment. Herein, the data collected by the equipment during the operation of the equipment is called a “log”. For example, the log includes a history of the operation status, the occurrence of errors, maintenance performed, process parameters, number of processed workpieces, energy consumption, operations by users, the surrounding environment, communications, etc.

It is desirable for the production efficiency of each equipment to be high. To increase the production efficiency, it is desirable to reduce the error count when processing workpieces, process more workpieces in a short period of time, etc. For example, it is desirable for equipment that supplies workpiece components to have a low error rate, a high number of components supplied per unit time, etc.

To increase the production efficiency, it is effective to identify causes that reduce the production efficiency and eliminate such causes. Logs may include information useful for identifying causes that reduce the production efficiency. On the other hand, logs include much data. Also, the data that is collected is different between manufacturers and between equipment. It is therefore not easy to obtain clues to improve the production efficiency by analyzing the logs.

Embodiments of the invention provide technology in which various information related to equipment can be displayed on a screen of a terminal device based on logs collected by the equipment.

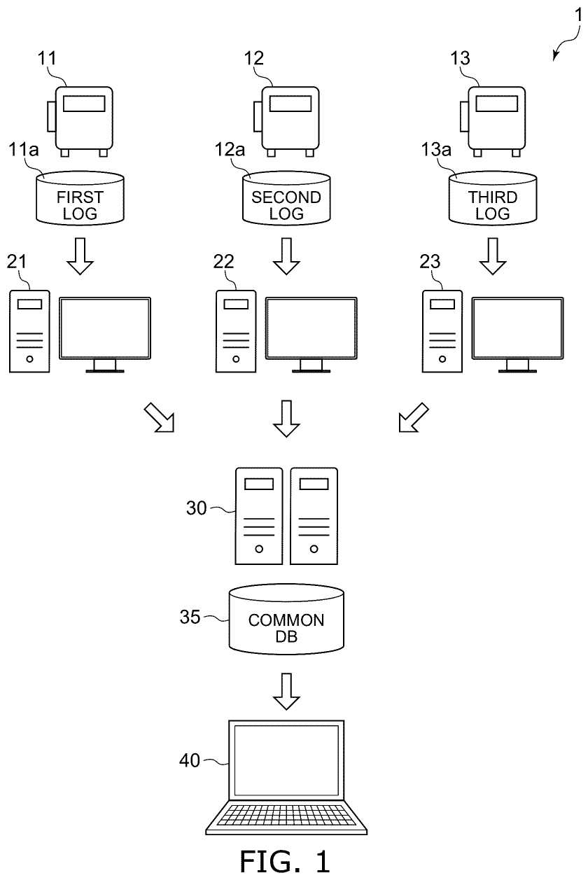

FIG. 1 is a schematic view showing an application example of an embodiment.

For example, as shown in FIG. 1, a first equipment 11, a second equipment 12, and a third equipment 13 are used in a manufacturing site. The first equipment 11 is a machine manufactured by a first manufacturer. The first equipment 11 collects data when operating and generates a first log 11a. The second equipment 12 is a machine manufactured by a second manufacturer. The second equipment 12 collects data during the operation and generates a second log 12a. The third equipment 13 is a machine manufactured by a third manufacturer. The third equipment 13 collects data during the operation and generates a third log 13a.

The first equipment 11 can communicate with a personal computer (PC) 21 attached to the equipment. The communication method is arbitrary, and is a network line, wired communication, wireless communication, etc. The PC 21 receives the first log 11a from the first equipment 11. The second equipment 12 can communicate with a PC 22. The PC 22 receives the second log 12a from the second equipment 12. The third equipment 13 can communicate with a PC 23. The PC 23 receives the third log 13a from the third equipment 13.

The PCs 21 to 23 can communicate with a server 30. The server 30 receives the first log 11a, the second log 12a, and the third log 13a respectively from the PCs 21 to 23. The server 30 stores the data included in the logs in a common database 35. At this time, the data of each log is converted according to a prescribed interface prepared for each equipment and for each manufacturer. The converted data is stored in a common format in the common database 35.

A terminal device 40 displays the data stored in the common database 35 on a screen that can be viewed by a user. The terminal device 40 is a general-purpose PC, a tablet, a smartphone, etc.

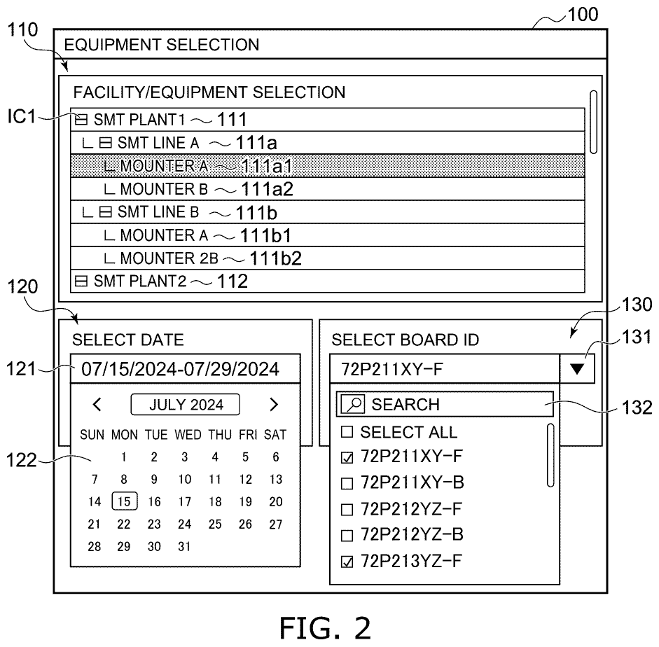

FIG. 2 is a schematic view illustrating a first user interface displayed by a display method according to an embodiment.

Here, the embodiment of the invention describes an example applied to equipment (a mounter) that performs surface mounting of parts. For example, the first user interface 100 shown in FIG. 2 is displayed on the screen of the terminal device 40. The first user interface 100 includes an equipment selection area 110, a date selection area 120, and a board selection area 130.

The user can select a facility and equipment in the equipment selection area 110. A facility 111 and a facility 112 are displayed in the illustrated example. A “facility” includes multiple manufacturing lines. Manufacturing lines 111a and 111b are displayed in a tree format in the facility 111. A “manufacturing line” includes multiple equipment. Equipment 111a1 and 111a2 are displayed in a tree format in the manufacturing line 111a. Equipment 111b1 and 111b2 are displayed in a tree format in manufacturing line 111b.

An icon IC1 is displayed for each facility and each manufacturing line to expand or collapse the items. By clicking the icon IC1, the user can expand or collapse the items (the manufacturing lines) included in the facility and expand or collapse the items (the equipment) included in the manufacturing lines.

The user selects equipment of which the information is to be displayed from among the multiple equipment displayed in the tree format. The user can select multiple equipment in the equipment selection area 110. For example, when equipment is selected, the color of the area including the equipment name is changed.

The user can select a period in the date selection area 120. When the period is selected, information is displayed based on the data collected by the equipment in the period. The date selection area 120 includes an input area 121.

The user inputs the start and end of the period in the input area 121. For example, as shown in FIG. 2, a calendar 122 is displayed when the user clicks the input area 121. The user selects the start date of the period and the end date of the period in the calendar 122. Or, the user may be able to directly input the date in the input area 121. The time also may be specifiable in the input area 121. In the illustrated example, the period from Jul. 15 to Jul. 29, 2024 (an example of a first period) is selected.

The board selection area 130 includes a pull-down menu 131. When the user clicks the pull-down menu 131, a list of boards (lots) processed by the equipment selected in the equipment selection area 110 are displayed. The board selection area 130 also includes a search bar 132. The user can search for a specific board by inputting the board ID in the search bar 132.

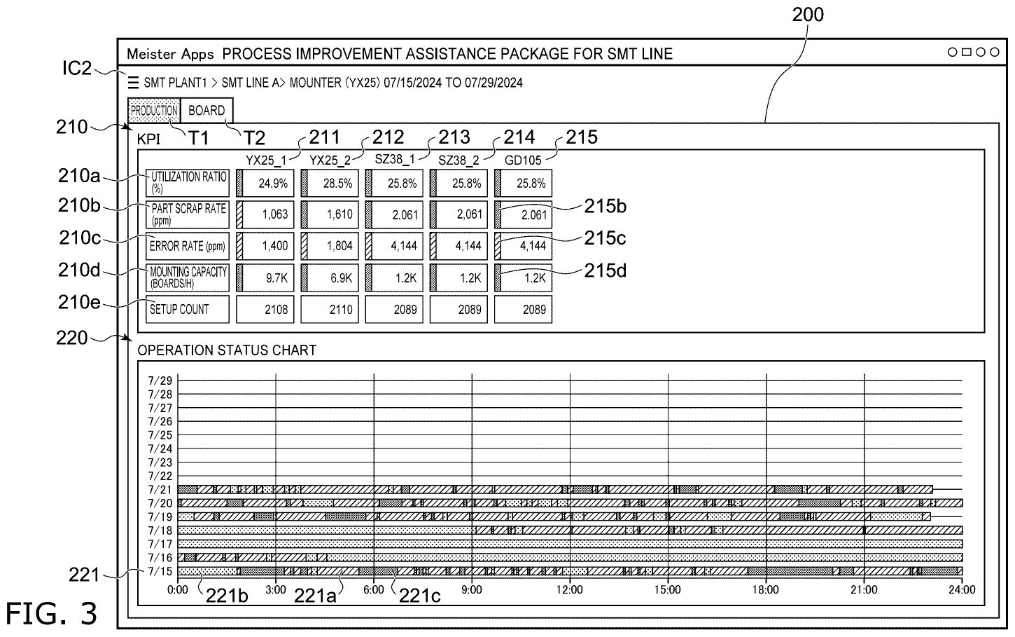

FIG. 3 is a schematic view illustrating a second user interface displayed by the display method according to the embodiment.

The second user interface 200 shown in FIG. 3 also is displayed on the screen of the terminal device 40. The second user interface 200 includes a KPI display area 210 and a chart display area 220.

Indicators (Key Performance Indicators: KPIs) related to the production efficiency are displayed in the KPI display area 210 for each equipment. The KPIs displayed in the illustrated example are a utilization ratio 210a, a part scrap rate 210b, an error rate 210c, a mounting capacity 210d, and a setup count 210e.

The utilization ratio 210a indicates the ratio of the time that the equipment actually operated to the time period in which the equipment was operatable. For example, the utilization ratio 210a is calculated by the following Formula (1). In Formula (1), the “production end time” is the time at which the processing of a production lot of the equipment ended. The “setup end time” is the time at which the setup for starting production of the lot of the equipment ended. The “error stop time” is the time from the occurrence of an error in the lot until an operator stops an alarm. The “error recovery time” is the time after the alarm is stopped until operation of the equipment can be restarted. The “upstream standby time” is the portion of the standby time of the equipment due to a cause in an upstream process. The “downstream standby time” is the portion of the standby time of the equipment due to a cause in a downstream process. The “operator stop time” is the time from the equipment being stopped by the operator until automatic operation is restarted. When boards are processed in multiple lanes inside the mounter, the “other lane waiting time” is the waiting time while mounting is being performed in another conveying lane, and is the waiting time from when a board is fixed in one conveying lane until the mounting for the board is started. Formula (1) calculates the operation time of the equipment per production lot. The overall operation time in the selected period is calculated by repeating the calculation of the operation time for each production lot in the selected period.

$$Operation time ( h ) = \{ ( production end time - setup end time ) - ( error stop time ( s ) + error recovery time ( s ) + upstream standby time ( s ) + downstream standby time ( s ) + operator stop time ( s ) + other lane waiting time ( s ) ) \} / 3600 \qquad ( 1 )$$

Similarly, Formula (2) calculates the setup time of the equipment for one production lot.

$$Setup time ( h ) = ( setup end time - previous lot production end time ) / 3600 \qquad ( 2 )$$

Formula (3) calculates the waiting time of the equipment for one production lot. Formula (4) calculates the error stop time of the equipment for one production lot.

$$Waiting time ( h ) = ( upstream standby time ( s ) + downstream standby time ( s ) + other lane waiting time ( s ) ) / 3600 \qquad ( 3 )$$

$$Error stop time ( h ) = ( error stop time ( s ) + error recovery time ( s ) ) / 3600 \qquad ( 4 )$$

Formula (5) calculates the utilization ratio by using the values obtained in Formulas (1) to (4).

$$Utilization ratio ( \% ) = operation time ( h ) / \{ operation time ( h ) + setup time ( h ) + waiting time ( h ) + error stop time ( h ) \} \times 100 \qquad ( 5 )$$

The part scrap rate 210b is the ratio of the amount of scrapped components to the total amount of components used by the equipment. For example, for a mounter, the part scrap rate 210b is the ratio of the number of scrapped part to the total number of parts used. The mounter receives a supply of parts from a feeder and picks up the supplied parts. The mounter then aligns the part with respect to the board and mounts the part on the board. A part is considered to be used when the part is picked up by the mounter. The difference between the number of parts used and the number of parts mounted is calculated as the number of scrapped parts. For example, parts that are dropped due to a failed pickup, parts that are dropped while being transferred, etc., are treated as parts that are used but not mounted, and are counted in the number of scrapped parts. For example, the part scrap rate 210b is represented by the following Formula (6). In Formula (6), the “actual board count” is the number of boards on which parts are mounted by the equipment. The “number mounted” is the number of parts mounted by the equipment on one board. The product of the actual board count and the number mounted represents the total number of parts mounted on the board.

$$\{ consumed part count - ( actual board count ( boards ) \times number mounted ) \} / ( actual board count ( boards ) \times number mounted ) \qquad ( 6 )$$

The error rate 210c is the ratio of the number of times that an error occurred to the total number of pickups performed on the parts. For example, the error rate 210c is represented by the following Formula (7). In Formula (7), the “pickup error count” is the number of failed part pickups. The “part recognition error count” is the number of failed recognitions of the supplied parts. The “raised lead error count” is, for example, the number of occurrences of an IC part or the like that is raised with respect to the board when mounting due to deformation of a lead of the part from the predefined shape. The “mark recognition error count” is the number of failed recognitions of alignment marks on the board. The “transfer error count” is the number of failed transfers of the part. The “other error count” is the number of errors not classified into the five types described above. For example, errors not classified into the five types include mounting errors, dropped part errors, etc. The mounting error count is the number of errors related to the position, orientation, etc., when mounting the part on the board. The dropped part error count is the number of parts dropped by the equipment.

$$( Pickup error count + part recognition error count + raised lead error count + mark recognition error count + transfer error count + other error count ) / total pickup count \qquad ( 7 )$$

The error count may be displayed in addition to the error rate 210c or instead of the error rate 210c. However, the error count may increase as the operation time of the equipment increases or as the amount of processing of the equipment increases. For example, it is favorable to use an error rate indicator when equipment with short operation times and equipment with long operation times are evaluated equally.

The mounting capacity 210d displays the number of parts mounted per hour. The mounting capacity 210d indicates the number of components that were supplied to the workpiece per unit time. In the illustrated example, the mounted part count is represented by the product of the “actual board count” and the “number mounted”. The mounting capacity 210d indicates how quickly the equipment mounts parts. The setup count 210e is the number of setup tasks such as program changes, etc. A setup task is performed for each lot. Therefore, the setup count 210e is equal to the number of lots processed by the equipment.

In the example shown in FIG. 3, five common KPIs are displayed for five pieces of equipment 211 to 215. The KPI display area 210 also includes a display area showing evaluation results of the KPIs for each equipment. Specifically, the evaluation of each of the pieces of equipment 211 to 215 is indicated by a color adjacent to each KPI.

A threshold for determining the goodness of each KPI is preset for each KPI. A first color is displayed in the display area adjacent to the KPI when the KPI is favorable when compared to the threshold. A second color that is different from the first color is displayed in the display area adjacent to the KPI when the KPI is unfavorable when compared to the threshold.

As an example, the error rate of the equipment 215 is compared to a preset first threshold. It is favorable for the error rate to be low. The error rate of the equipment 215 is less than the first threshold. In such a case, the first color (an example of a first comparison result) indicating that the error rate is favorable is displayed in a display area 215c adjacent to the error rate of the equipment 215.

As another example, the mounting capacity (the mounted part count per unit time) of the equipment 215 is compared to a preset second threshold. It is favorable for the mounting capacity to be high. The mounting capacity of the equipment 215 is less than the second threshold. In such a case, the second color (an example of a second comparison result) indicating that the mounting capacity is unfavorable is displayed in a display area 215d adjacent to the mounting capacity of the equipment 215.

The other indicators also are compared to preset thresholds. For example, the part scrap rate of the equipment 215 is compared to a preset third threshold. It is favorable for the part scrap rate to be low. The part scrap rate of the equipment 215 is less than the third threshold. In such a case, the second color (an example of a third comparison result) indicating that the part scrap rate is unfavorable is displayed in a display area 215b adjacent to the part scrap rate of the equipment 215.

Instead of providing a display area adjacent to the KPI, the colors that indicate the evaluation may be displayed in the display area of the KPI. Or, instead of colors, the evaluation result may be indicated by displaying symbols or textures.

In the chart display area 220, when the selected period is subdivided into multiple sub-periods (one day), the breakdown of the operation status in each sub-period is displayed in a chart (a first chart). In the example shown in FIG. 3, the time of day is displayed on the horizontal axis, and the date is displayed on the vertical axis. In each sub-period, three classifications of operation status are displayed with mutually-different colors.

For example, a bar 221 of “July 15” displays three classifications 221a to 221c in mutually-different colors. The classification 221a indicates that the equipment was operating. The classification 221b indicates that operation of the equipment was not planned. The classification 221c indicates that the equipment was stopped due to an error. To improve the production efficiency, it is favorable to reduce the time of the classification 221c. Also, it is favorable for the time of the classification 221b to be short, and for the equipment to be operated efficiently.

In addition to the second user interface 200, the screen displays an icon IC2 (a navigation bar), a tab T1, and a tab T2.

The icon IC2 is displayed to switch between expansion and collapse of the first user interface 100. When the user clicks the icon IC2, the first user interface 100 shown in FIG. 2 is displayed to overlap the second user interface 200. When the user selects the equipment and the period in the first user interface 100, the selection results are reflected in the second user interface 200.

The tabs T1 and T2 are displayed to switch between interfaces. When the user clicks the tab T1, the second user interface 200 shown in FIG. 3 can be displayed on the screen. When the user clicks the tab T2, a third user interface, which is described below, can be displayed on the screen. When displaying an interface, the display of the corresponding tab is changed so that the user can easily recognize the interface being displayed. In the illustrated example, the color of the tab T1 is different from the color of the tab T2.

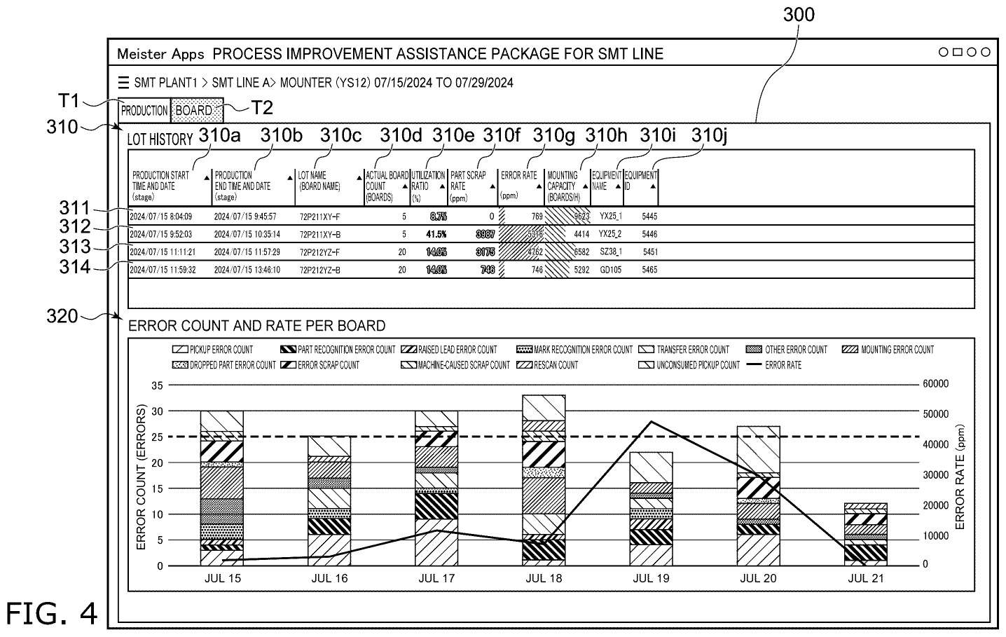

FIG. 4 is a schematic view illustrating a third user interface displayed by the display method according to the embodiment.

The third user interface 300 shown in FIG. 4 also is displayed on the screen of the terminal device 40. The second user interface 200 displays indicators for each equipment. The third user interface 300 displays the indicators for each equipment subdivided for each board (lot). The boards for which information is displayed in the third user interface 300 are selected in the board selection area 130 of the first user interface 100 shown in FIG. 2.

The third user interface 300 includes a KPI display area 310 and a chart display area 320. The KPI display area 310 displays a production start time and date 310a, a production end time and date 310b, a lot name 310c, an actual board count 310d, a utilization ratio 310e, a part scrap rate 310f, an error rate 310g, a mounting capacity 310h, an equipment name 310i, and an equipment ID 310j for each of lots 311 to 314. The production start time and date 310a is the time at which mounting to the boards of the lot started. The production end time and date 310b is the time at which the mounting ended for all boards of the lot. The actual board count 310d is the number of boards on which the parts were appropriately mounted. The utilization ratio 310e, the part scrap rate 310f, the error rate 310g, and the mounting capacity 310h are the KPIs shown in the second user interface 200, subdivided for each lot.

The lot 311 is an example of a first lot. The lot 313 is an example of a second lot. The equipment “YX25_1” performs a prescribed processing (a first processing) on the lot 311. The equipment “SZ38_1” performs a prescribed processing (a second processing) on the lot 313.

At least some of the KPIs in the KPI display area 310 may display bars indicating the relative magnitudes between lots. In the example shown in FIG. 4, the magnitude relationship of the error rate of each lot is shown in the error rate 310g by colorized bars. The magnitude relationship of the mounting capacity of each lot also is shown in the mounting capacity 310h by colorized bars.

The display of at least some of the KPIs in the KPI display area 310 may be changed according to the evaluation. For example, a threshold is preset for each KPI. In the example shown in FIG. 4, two thresholds are set for each KPI; and each KPI is evaluated as one of three levels (good, acceptable, or unacceptable). In the utilization ratio 310e, the lot 312 is determined to be “acceptable”; and the lots 311, 313, and 314 are determined to be “unacceptable”. The color of the utilization ratio of the lot 312 is different from the colors of the utilization ratios of the lots 311, 313, and 314. In the part scrap rate 310f, the lot 311 is determined to be “good”; and the lots 312 to 314 are determined to be “unacceptable”. The color of the part scrap rate of the lot 311 is different from the colors of the part scrap rates of the lots 312 to 314.

In the chart display area 320, when the selected period is subdivided into multiple sub-periods (one day), the error count and the error breakdown in each sub-period are displayed in a chart (a second chart). In the example shown in FIG. 4, the date is displayed on the horizontal axis, and the error count and error rate are displayed on the vertical axes. The bar that is displayed at each date displays a color-coded breakdown of errors. The illustrated example displays the number of each error type, including “pickup error”, “part recognition error”, “raised lead error”, “mark recognition error”, “transfer error”, “mounting error”, “dropped part error”, “error scrap”, “machine-caused scrap”, “rescan”, and “other error”. “Error scrap” indicates the portion of the part scrap count due to errors that does not fall under any of machine-caused scrap, pickup error, and rescanning. “Machine-caused scrap” indicates the portion of the part scrap count due to a machine that does not fall under pickup error. “Rescanning” indicate the number of times that part recognition was re-performed.

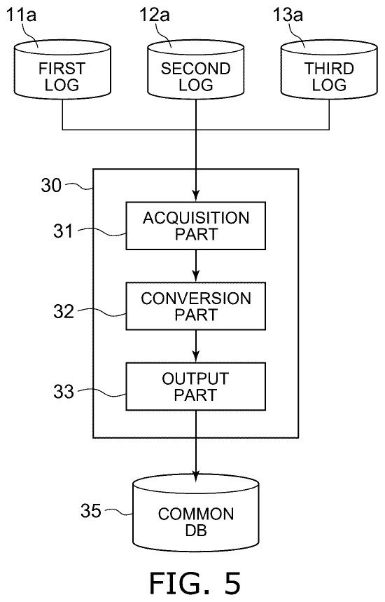

FIG. 5 is a block diagram schematically showing functions of a server.

As shown in FIG. 5, the server 30 functions as an acquisition part 31, a conversion part 32, and an output part 33. The acquisition part 31 communicates with the PCs 21 to 23 and acquires the first to third logs 11a to 13a.

The conversion part 32 converts the data included in the logs into a common format. For example, the conversion part 32 extracts first to third datasets respectively from the first to third logs 11a to 13a. The conversion part 32 converts the first dataset into common data by performing the first processing on the first dataset. The conversion part 32 converts the second data into common data by performing the second processing on the second data. The conversion part 32 converts the third dataset into common data by performing a third processing on the third dataset. The output part 33 outputs the converted data to the common database 35 and stores the converted data in the common database 35.

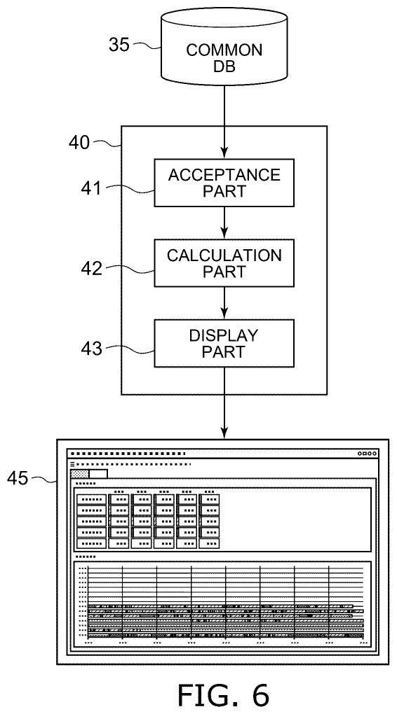

FIG. 6 is a block diagram schematically showing functions of a terminal device.

As shown in FIG. 6, the terminal device 40 functions as an acceptance part 41, a calculation part 42, and a display part 43. The acceptance part 41 acquires the information (the period and the equipment) selected by the user in the first user interface 100. The acceptance part 41 acquires the data of the selected equipment for the selected period from the common database 35.

Based on the acquired data, the calculation part 42 calculates indicators related to the selected equipment for the selected period. For example, when calculating the utilization ratio, data such as the “production end time”, the “setup end time”, the “error stop time”, the “error recovery time”, the “upstream standby time”, the “downstream standby time”, the “operator stop time”, the “other lane waiting time”, the “setup end time”, the “previous lot production end time”, the “upstream standby time”, the “downstream standby time”, the “error stop time”, the “error recovery time”, etc., are acquired for the selected equipment for the selected period. These data are used to calculate the “setup time”, the “waiting time”, and the “error stop time”. The “setup time”, the “waiting time”, and the “error stop time” are used to calculate the “utilization ratio”. Similarly, for the other indicators as well, the data that is used in the formulas above are acquired from the common database 35; and the indicators are calculated. The calculation part 42 also calculates the indicators related to the equipment for each lot.

The display part 43 displays, on a screen 45 of the terminal device 40, the second user interface 200 including the indicators related to the equipment or the third user interface 300 including the indicators for each lot.

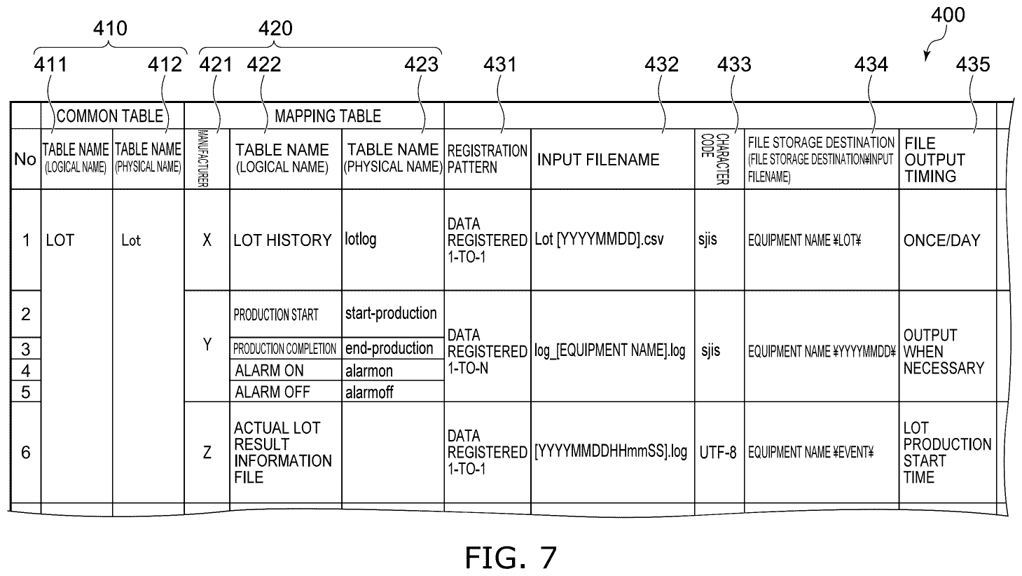

FIGS. 7 to 9 are tables illustrating rules for converting the logs.

For example, the conversion rules shown in FIGS. 7 to 9 are referenced when converting the logs collected by the equipment into a common data format.

Rules 400 shown in FIG. 7 define rules for mapping the logs collected by the equipment to the common database 35. The rules 400 include multiple columns including a common table 410, a mapping table 420, a registration pattern 431, a filename 432, a character code 433, a storage destination 434, and an output timing 435.

The common table 410 includes a table name 411 and a table name 412. The table name 411 lists the logical name of the common table. The logical name is the name of the table set for easy recognition by the user. The table name 412 lists the physical name of the common table. The physical name is the name by which the table is referenced by a computer.

The mapping table 420 includes a manufacturer 421, a table name 422, and a table name 423. The manufacturer 421 lists the name of the manufacturer that manufactured the equipment. The table name 422 is the logical name of the table including data related to the items listed in the common table 410. The table name 423 lists the physical name of the table including data related to the items listed in the common table 410.

For the equipment of a manufacturer X in the example shown in FIG. 7, the data related to the lot is stored in a table with the logical name “lot history”. For the equipment of a manufacturer Y, the data related to the lot is stored in the table with the four logical names “production start”, “production completion”, “alarm on”, and “alarm off”. The data that corresponds to the lot for each manufacturer is converted into the data of the lot of the common database 35 according to the rules 400.

The registration pattern 431 lists how the data of the mapping table 420 corresponds to the data of the common table 410 as registered. The filename 432 lists the filename of the data of the mapping table 420. The character code 433 lists the character code when the equipment handles the data of the mapping table 420. The storage destination 434 lists the storage destination of the data of the mapping table 420. The output timing 435 lists the output timing of the datafile of the mapping table 420.

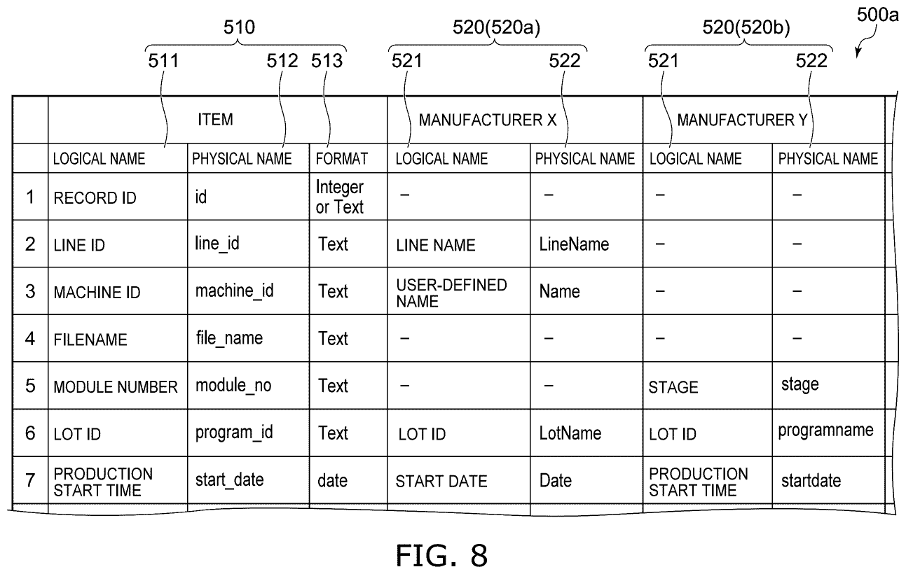

Rules 500a shown in FIG. 8 define specific processing when mapping the data of the logs to the common database 35. The rules 500a include multiple columns including an item 510 and a conversion object item 520.

The item 510 includes a logical name 511, a physical name 512, and a format 513. The logical name 511 and the physical name 512 respectively list the logical name and the physical name of the data after conversion. The format 513 lists the format of the data after conversion. That is, the item 510 shows items of the common database 35.

The conversion object item 520 includes a logical name 521 and a physical name 522. The logical name 521 and the physical name 522 list the logical name and the physical name of the data for each manufacturer. The log data is acquired and stored in the common database 35 based on the logical name 521 and the physical name 522. The rules 500a shown in FIG. 8 include a conversion object item 520a related to the equipment of the manufacturer X and a conversion object item 520b related to the equipment of the manufacturer Y. When the logical name 521 and the physical name 522 of the conversion object item 520 are blank (in FIG. 8, when a hyphen is input), data is acquired from a source other than the log data. Or, there are also cases where data is not acquired.

In the example shown in FIG. 8, the common database 35 lists rules for generating data for the “record ID”, the “line ID”, the “machine ID”, the “filename”, the “module number”, the “lot ID”, and the “production start time”.

For example, for the “line ID”, according to the conversion object item 520a, data is acquired from the table of the logical name “line name” and the physical name “LineName” in the log output from the equipment of the manufacturer X; and the data is registered in text form in the table of the “line ID” of the common database 35. The “record ID”, the “filename”, and the “module number” are examples of acquiring data from a source other than the log data; for example, for the “record ID”, data (an ID) is automatically numbered by the server 30 and registered in integer form or text form. For the “module number”, the conversion object item 520b is set for the manufacturer Y and so the log data is acquired; however, the conversion object item 520a is not set for the manufacturer X, and so the log data is not acquired.

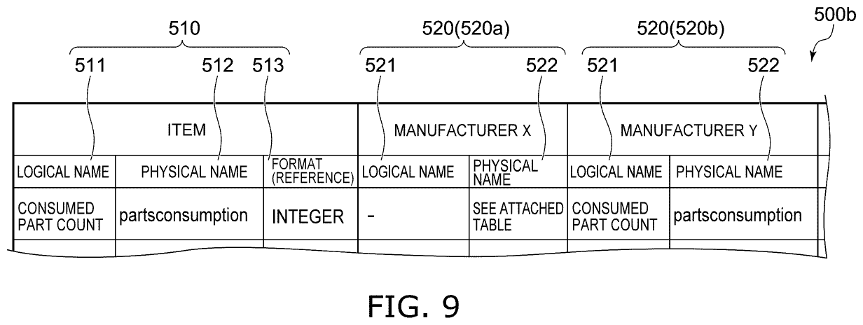

In rules 500b shown in FIG. 9, the common database 35 lists rules for generating the data of the “consumed part count”. Another example of the processing when mapping the logs will now be described using FIG. 9.

In the illustrated example, the log that is output from the equipment of the manufacturer Y includes a table directly corresponding to the consumed part count. Therefore, the data of the consumed part count can be obtained by referring to the corresponding table of the log. On the other hand, the log that is output from the equipment of the manufacturer X does not include data corresponding to the consumed part count. It is therefore necessary to calculate the consumed part count based on other data included in the log. In the example shown in FIG. 9, the calculation method of the consumed part count is defined by another table; and the consumed part count is calculated according to the definition.

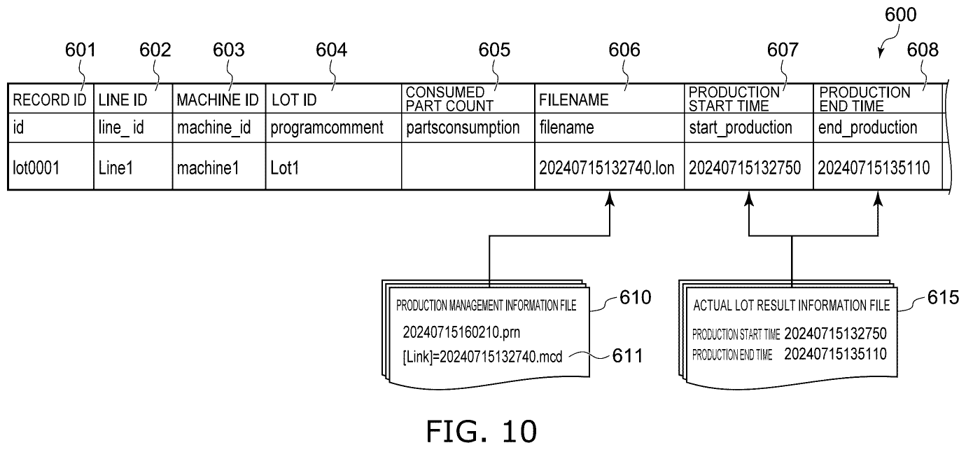

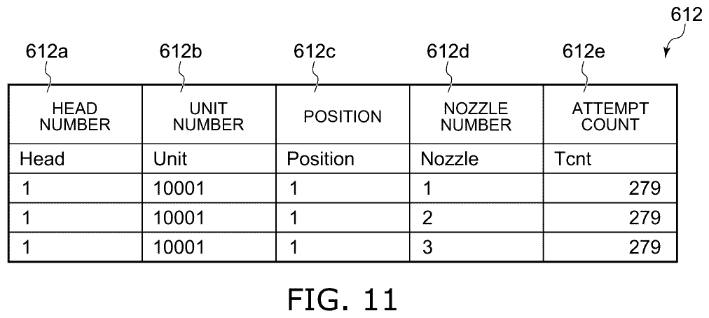

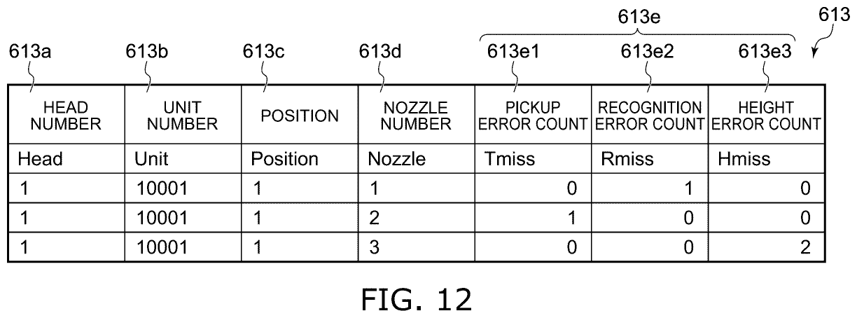

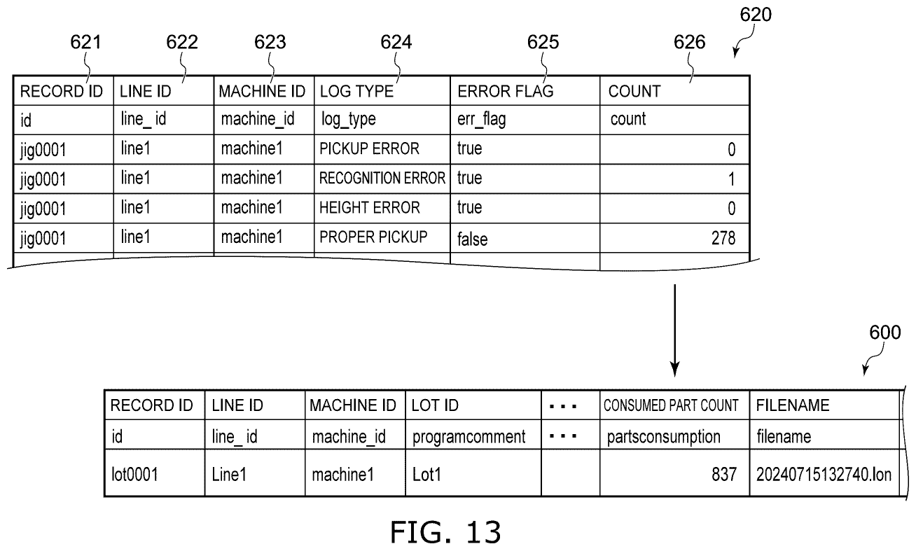

FIGS. 10 and 13 are tables illustrating data registered in the common database. FIGS. 11 and 12 are tables illustrating data included in the logs.

A specific example of the calculation method of the consumed part count will now be described with reference to FIGS. 10 to 12, which illustrate lot tables. First, the acquisition part 31 acquires the logs of each equipment. The conversion part 32 generates a lot table 600 shown in FIG. 10 and stores the lot table 600 in the common database 35. The lot table 600 includes a record ID 601, a line ID 602, a machine ID 603, a lot ID 604, a consumed part count 605, a filename 606, a production start time 607, and a production end time 608. The record ID 601 is a unique character string that identifies the data. The line ID 602, the machine ID 603, and the lot ID 604 are unique character strings that respectively identify the manufacturing line, the equipment, and the lot. The machine ID 603 and the lot ID 604 are referenced when calculating the indicators for each equipment or the indicators for each lot. The consumed part count 605 is blank when the lot table 600 is generated, receives a tally for each lot according to the calculation method of the consumed part count described below, and reflects the tally result.

The conversion part 32 refers to a log 610 generated by the equipment of the manufacturer X. The log 610 includes, in a section named “Link”, a file 611 including data for each lot. The conversion part 32 inputs the name of the file 611 to the filename 606 of the lot table 600.

The conversion part 32 also refers to a log 615 generated by the equipment of the manufacturer X. The log 615 includes the production start time and the production end time for each lot. The conversion part 32 inputs the production start time and the production end time included in the log 615 in the production start time 607 and the production end time 608 of the lot table 600.

The log 610 also includes data related to pickup by the mounter. For example, the mounter includes a head to which multiple nozzles are mounted. When mounting a part, the mounter picks up the part with one of the nozzles and places the part on the board. The log 610 includes a table 612 (shown in FIG. 11) showing the pickup count for each nozzle and a table 613 (shown in FIG. 12) showing the error count for each nozzle.

The table 612 shown in FIG. 11 includes a head number 612a, a unit number 612b, a position 612c, a nozzle number 612d, and an attempt count 612e. The head number 612a is a character string that identifies each head from among one or more heads included in one mounter. The unit number 612b is a character string that identifies each unit from among multiple units included in one mounter. The position 612c indicates the position of the head inside the mounter. The nozzle number 612d is a character string that identifies each nozzle from among one or more nozzles mounted to one head. The attempt count 612e is the number of times that each nozzle attempted a pickup.

The table 613 shown in FIG. 12 includes a head number 613a, a unit number 613b, a position 613c, a nozzle number 613d, and an error count 613e. Similarly to the head number 612a, the unit number 612b, the position 612c, and the nozzle number 612d, the head number 613a, the unit number 613b, the position 613c, and the nozzle number 613d are data for identifying the head, the unit, the nozzle, etc. The error count 613e is the number of times that an error occurred during pickup by each nozzle.

In the illustrated example, the errors are classified into three classifications. The error count 613e includes a pickup error count 613e1, a recognition error count 613e2, and a height error count 613e3. The pickup error count 613e1 is the number of times that pickup failed when the nozzle attempted to pick up a part. The recognition error count 613e2 is the number of times that the mounter failed to recognize marks for alignment in in-plane directions (the X-direction and the Y-direction) when mounting the part on the board. The height error count 613e3 is the number of times that the mounter failed to align the part in the height direction (the Z-direction) when mounting the part on the board.

The conversion part 32 generates a jig table 620 shown in FIG. 13 by using the data of the tables 612 and 613. The jig table 620 includes a record ID 621, a line ID 622, a machine ID 623, a log type 624, an error flag 625, and a count 626. In the illustrated example, the “jig” refers to the nozzle. The record ID 621 is a unique character string assigned to each nozzle. The line ID 622 and the machine ID 623 are unique character strings that respectively identify the manufacturing line and the equipment. The log type 624 indicates the type of data in each row. The error flag 625 indicates whether or not the data in the row is related to an error. The count indicates the error count or the proper pickup count.

The conversion part 32 subtracts the error count 613e of the table 613 from the attempt count 612e of the table 612. The number of times that proper pickup was performed without an error is obtained thereby. Each error count is obtained from the pickup error count 613e1, the recognition error count 613e2, and the height error count 613e3 of the table 613. The conversion part 32 stores the error counts as the count in the jig table 620.

The example shown in FIGS. 11 and 12 includes logs related to three nozzles. The conversion part 32 calculates the error counts and the proper pickup count for each nozzle. The conversion part 32 calculates the overall consumed part count by totaling the counts. The data of the table 612 and the data of the table 613 are generated for each lot, but are not directly associated with the lot data. Therefore, the conversion part 32 refers to the filename of the file 611 and associates the data of the table 612 and the data of the table 613 with the data of the lot table 600. As a result, as shown in FIG. 12, the consumed part count that is calculated is recorded in the consumed part count 605 of the lot table 600. As a result, the consumed part count is obtained for each lot.

Similarly to the example shown in FIGS. 10 to 13, the other data necessary to calculate the indicators are converted from the data of the logs as appropriate and stored in the common database 35. For example, the value of the various error counts subtracted from the consumed part count shown in FIG. 13 corresponds to the mounted part count. The part scrap rate can be calculated using the consumed part count and the mounted part count. As shown in Formula (6) above, the mounted part count also can be calculated using the product of the “actual board count” and the “number mounted”. In such a case, the data of the logs is converted into the “actual board count” and the “number mounted” and stored in the common database 35. The attempt count 612e of the table 612 and the error count 613e of the table 613 are used to calculate the error rate.

Data necessary to calculate other indicators such as the utilization ratio, the setup count, etc., also is converted as appropriate from the data of the logs output from the equipment and stored in the common database 35. When calculating the indicators, the data is acquired from the common database 35 and used to calculate the indicators.

The conversion part 32 maps the data of the logs collected by the equipment to the common database 35 according to the illustrated mapping rules. When mapping, the conversion part 32 converts the log data according to the processing shown in FIG. 8, FIG. 9, etc. As a result, the logs that are collected using different filenames and data formats for each equipment are stored in the common database 35 with common filenames and data formats.

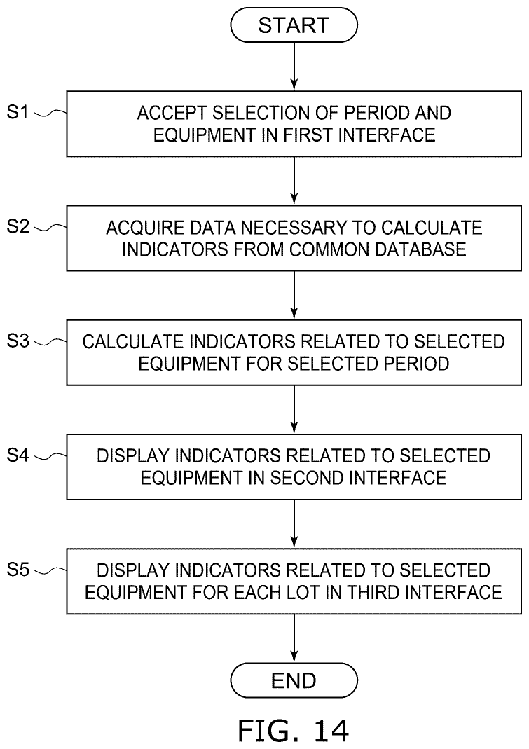

FIG. 14 is a flowchart showing a display method according to an embodiment.

First, the acceptance part 41 of the terminal device 40 accepts the selection of the period and the selection of the equipment by the user in the first user interface 100 (step S1). Upon accepting the selections, the acceptance part 41 acquires data necessary to calculate the indicators from the common database 35 (step S2). According to the embodiment, the indicators are the KPI 210 shown in FIG. 2, i.e., the utilization ratio 210a, the part scrap rate 210b, the error rate 210c, the mounting capacity 210d, and the setup count 210e. For example, the acceptance part 41 refers to the data associated with the ID of the selected equipment. Then, to calculate the operation ratio, the data of the “production end time”, the “setup end time”, the “error stop time”, the “error recovery time”, the “upstream standby time”, the “downstream standby time”, the “operator stop time”, the “other lane waiting time”, the “setup end time”, the “previous lot production end time”, the “upstream standby time”, the “downstream standby time”, the “error stop time”, and the “error recovery time” for the selected period is acquired from the common database 35. Similarly, for the data necessary to calculate the other indicators, the prescribed data for the selected period among the data associated with the ID of the selected equipment is acquired from the common database 35. For example, to calculate the part scrap rate, the data of the “consumed part count”, the “actual board count”, and the “number mounted” is acquired from the common database 35. To calculate the error rate, the data of the various error counts and the total pickup count are acquired from the common database 35. For the setup count, the “setup count” is registered in the common database 35, and the numerical value of the “setup count” is acquired.

The calculation part 42 uses the acquired data to calculate the indicators related to the selected equipment for the selected period and the indicators for each lot by using Formulas (1) to (7) above (step S3). As a result, the indicators of the “utilization ratio”, the “part scrap rate”, the “error rate”, the “mounting capacity”, and the “setup count” are obtained for each equipment and for each lot.

The display part 43 displays the calculated indicators in the second user interface 200 (step S4). The display part 43 also displays the indicators of the selected equipment for the selected period for each lot in the third user interface 300 (step S5).

Advantages of embodiments will now be described.

According to the embodiments, for example, as shown in FIG. 2, the first user interface 100 that accepts the selection of the equipment and the selection of the period is displayed on the screen of the terminal device 40. The user can use the first user interface 100 to arbitrarily select the period and the equipment of which information is to be displayed. When the period and the equipment are selected in the first user interface 100, the second user interface 200 that includes information of the selected period is displayed. The second user interface 200 displays indicators such as the error rate, the supplied component count, etc., related to the selected equipment.

The error rate and the supplied component count are particularly useful indicators to increase the production efficiency of the equipment. Based on these indicators, the user can estimate what should be improved on the equipment.

For example, the following four main causes may be considered when the error rate or the supplied component count is unfavorable.

The first cause is related to the operation or setting of the apparatus. For example, the indicators may be reduced if there is a mistake of the coordinate data, an inappropriate setting of the image recognition data, a setting mistake of the pickup conditions, insufficient optimization of part placement, a program bug, misadjustment of feeder vibration settings, misadjustment of the feed rate of the feeder, or a setting mistake of the feeder position.

The second cause is related to the handling method when errors occur. When a discrepancy or a problem with the equipment occurs, the indicators may be reduced if an appropriate action is not performed. For example, when an error occurs in the equipment, the error tends to occur again in the equipment if there is insufficient cleaning, inappropriate adjustment, insufficient confirmation of the error log, a misoperation of the software, etc.

The third cause is related to maintenance. Equipment errors tend to occur and the indicators may be reduced if maintenance is insufficient, calibration in maintenance is insufficient, software is not appropriately updated, the suction pressure is not adjusted, etc.

The fourth cause is related to quality control of components supplied to the workpieces. For example, the supplied components tend to cause defects to occur more easily if the component quality is insufficiently inspected before setting the component at the equipment, the components are stored in an inappropriate environment, components that should be scrapped are erroneously used, etc. The indicators may be reduced thereby.

The user checks the presence or absence of a cause based on the displayed indicators and takes action to eliminate the cause as necessary. The error rate or the supplied component count of the equipment can be improved thereby. The production efficiency of the equipment can be increased.

According to an embodiment, the user can arbitrarily select the period in the first user interface 100. For example, the user can check the error rate and the supplied component count for each period while modifying the period. As a result, it is easier to identify the cause. For example, when some indicator is reduced for only a specific period, it is considered that a temporary cause occurred in the period. When some indicator is reduced regardless of the period, it is considered that a permanent cause has occurred.

The indicators such as the error rate, the supplied component count, etc., are generated based on the data collected by the equipment. As described above, the names, formats, and the like of the collected data are different for each equipment manufacturer. Various data are referenced to calculate the error rate and the supplied component count. Some equipment may not collect the data necessary for the calculations, and the necessary data may need to be calculated using other data. According to the embodiment, the error rate and the supplied component count are displayed for any equipment selected in the first user interface 100, regardless of manufacturer or equipment.

For example, according to the embodiment as shown in FIG. 3, the error rate and the supplied component count can be displayed for multiple equipment of different manufacturers. Common indicators can be used to compare multiple equipment that collect different data but perform the same processing. As a result, it is easier for the user to ascertain equipment needing an improvement of production efficiency. By comparing multiple equipment of different manufacturers, it is easier for the user to estimate causes of production efficiency reduction.

As shown in FIG. 3, it is favorable for the second user interface 200 to display comparison results between the indicators and preset thresholds. By displaying the comparison results, it is easier for the user to ascertain indicators needing improvement.

It is favorable for the second user interface 200 to display the component scrap rate, the utilization ratio, and the setup count in addition to the error rate and the supplied component count. The component scrap rate directly affects the production efficiency and the profit margin. The utilization ratio and the setup count directly affect the production efficiency. A high component scrap rate also may be due to the first to fourth causes described above. When the utilization ratio is low or the setup count is low, it may be necessary to improve the process of the workpiece. For example, by improving the process, the waiting time for workpieces to be supplied from upstream equipment or the standby time until transferring workpieces to upstream equipment is reduced. The utilization ratio and the setup count are improved thereby.

It is favorable for the second user interface 200 to display a chart of the operation status. The chart discriminably displays, for each sub-period, time periods in which the equipment operated, time periods in which the equipment did not operate, and time periods in which the first equipment was standing by. Multiple sub-periods are formed by subdividing the period selected in the first user interface 100. For example, by displaying a chart of time periods for each operation status in each sub-period, the user can easily ascertain time periods of which the utilization ratio should be improved. It is easier for the user to find what needs to be improved by checking the status of the equipment in the time periods, the workpiece flow, etc.

It is favorable to display the third user interface 300 shown in FIG. 4 on the screen of the terminal device 40. The third user interface 300 displays the start time of the processing, the end time of the processing, the error rate of the processing, and the supplied component count of the processing for each lot. In other words, the information that is displayed for each equipment in the second user interface 200 is displayed by being subdivided for each lot in the third user interface 300.

By checking the third user interface 300, the user can easily ascertain whether or not the cause of the indicator reduction is related to lots. When lots are involved, there is a possibility that the indicators can be improved by improving the processing of those lots.

As shown in FIG. 4, it is favorable for the third user interface 300 to display comparison results between the indicators and preset thresholds. By displaying the comparison results, it is easier for the user to ascertain indicators needing improvement.

As shown in FIG. 4, it is favorable for the third user interface 300 to display a chart showing the error count. It is favorable also for the causes of the errors to be discriminable in the chart. By checking the chart of the third user interface 300, the user can easily ascertain what kind of errors are causing higher error rates. The user can more easily estimate what needs to be improved to suppress the occurrence of errors and increase the production efficiency.

Similarly to the second user interface 200, information of multiple lots processed by equipment of different manufacturers are displayed side by side in the third user interface 300. By comparing those lots to a common indicator, the user can more easily ascertain equipment and lots for which the production efficiency should be improved.

By ascertaining the cause of reduced production efficiency for a specific equipment or lot, the production efficiency can be increased for the overall process related to the equipment or lot. For example, when the setup count of a specific equipment is low, the production efficiency of the overall process can be improved by modifying the processes to increase the setup count of that equipment.

An example is described above in which the display method according to the embodiment allows the display on the screen of the terminal device 40 to be switched between the second user interface 200 and the third user interface 300. For example, as shown in FIGS. 3 and 4, the user can display one of the interfaces by selecting a tab. Embodiments of the invention are not limited to this example. The display method according to the embodiment may be configured so that only one of the second user interface 200 or the third user interface 300 can be displayed, and the other interface is not displayed. The tabs are omitted in such a case. For example, even when only the third user interface 300 is displayed, the user can estimate what needs to be improved for the equipment based on the indicators displayed for each lot.

### Example

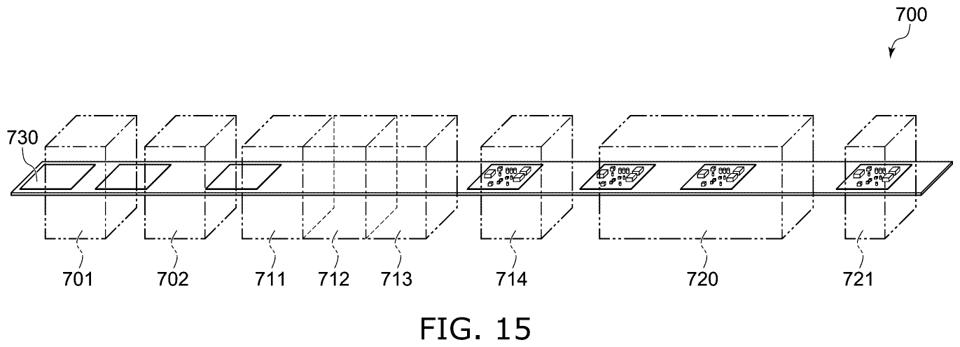

FIG. 15 is a schematic view showing an example.

A manufacturing line 700 shown in FIG. 15 performs surface mounting of parts on a board. The manufacturing line 700 includes a solder printer 701, a solder paste inspection machine 702, mounters 711 to 713, a visual inspection device 714, a reflow furnace 720, and a visual inspection device 721.

A board 730 is fed into the manufacturing line 700. The board 730 is, for example, a printed wired board (PWB). The solder printer 701 prints solder on the surface of the board 730. The solder paste inspection machine 702 inspects the printed solder. The mounters 711 to 713 mount parts on the printed solder. The visual inspection device 714 inspects the board 730 on which the parts are mounted. The reflow furnace 720 reflows the solder by heating the board. As a result, the mounted parts are bonded to the board 730. The visual inspection device 721 inspects the external appearance to determine whether or not the parts are appropriately bonded. A printed circuit board (PCB) having many parts mounted on the surface of the printed circuit board is manufactured by the processes described above. The board 730 is then visually inspected by the worker.

The mounters 711 to 713 collect data and generate logs. The log data is converted into a common format and stored in the common database 35. The indicators are then calculated using the data of the common database 35 and displayed as shown in FIGS. 3 and 4.

For example, the mounters 711 to 713 may be manufactured by mutually-different manufacturers. In such a case as well, according to embodiments, common indicators can be used to compare the mounters 711 to 713.

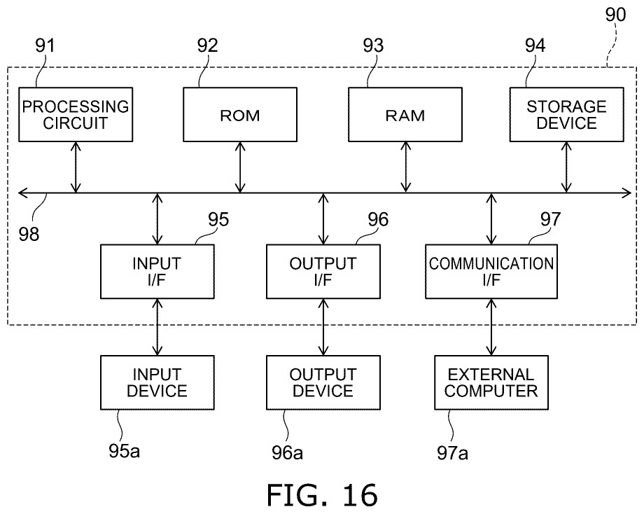

FIG. 16 is a schematic view illustrating a hardware configuration.

For example, a computer 90 shown in FIG. 16 is used as the server 30 or the terminal device 40. The computer 90 includes a processing circuits 91, ROM 92, RAM 93, a storage device 94, an input interface 95, an output interface 96, and a communication interface 97.

The ROM 92 stores programs controlling operations of the computer 90. The ROM 92 stores programs necessary for causing the computer 90 to realize the processing described above. The RAM 93 functions as a memory region into which the programs stored in the ROM 92 are loaded.

The processing circuit 91 includes an arithmetic processor such as a CPU, a GPU, etc. The processing circuit 91 uses the RAM 93 as work memory to execute the programs stored in at least one of the ROM 92 or the storage device 94. When executing the programs, the processing circuit 91 executes various processing by controlling configurations via a system bus 98.

The storage device 94 stores data necessary for executing the programs and/or data obtained by executing the programs.

The input interface (I/F) 95 can connect the computer 90 and an input device 95a. The input I/F 95 is, for example, a serial bus interface such as USB, etc. The processing circuit 91 can read various data from the input device 95a via the input I/F 95.

The output interface (I/F) 96 can connect the computer 90 and an output device 96a. The output I/F 96 is, for example, an image output interface such as Digital Visual Interface (DVI), High-Definition Multimedia Interface (HDMI (registered trademark)), etc. The processing circuit 91 can transmit data to the output device 96a via the output I/F 96 and cause the output device 96a to display an image.

The communication interface (I/F) 97 can connect the computer 90 and a computer 97a outside the computer 90. The communication I/F 97 is, for example, a network card such as a LAN card, etc. The processing circuit 91 can read various data from the external computer 97a via the communication I/F 97.

The storage device 94 includes at least one selected from a hard disk drive (HDD) and a solid state drive (SSD). The input device 95a includes at least one selected from a mouse, a keyboard, a microphone (audio input), and a touchpad. The output device 96a includes at least one selected from a monitor, a projector, a printer, and a speaker. A device such as a touch panel that functions as both the input device 95a and the output device 96a may be used.

The processing performed by the server 30 or the terminal device 40 may be realized by one computer 90, or may be realized by collaboration of multiple computers 90.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD±R, DVD±RW, etc.), semiconductor memory, or another non-transitory computer-readable storage medium.

For example, data of a recording medium is read by a computer (or an embedded system). The recording format (the storage format) of the recording medium is arbitrary. For example, the computer reads a program from the recording medium and causes a CPU to execute instructions based on the program. The acquisition (or the reading) of the program by the computer may be performed via a network.

The embodiments of the invention include the following features.

### Feature 1

A display method of displaying, on a screen of a terminal device, data related to equipment supplying components to a workpiece, the display method including:
displaying a first user interface configured to accept a selection of an equipment and a selection of a period; and
displaying a second user interface including an error rate and a supplied component count related to a first equipment selected in the first user interface for a first period selected in the first user interface.

### Feature 2

The display method according to feature 1, in which
the first user interface is configured to accept selections of a plurality of equipment of different manufacturers,
the first t is manufactured by a first manufacturer,
a second equipment is manufactured by a second manufacturer, and
the second user interface is configured so that, when the first equipment and the second equipment are selected in the first user interface, the second user interface displays:
   the error rate and the supplied component count related to the first equipment for the first period; and
   an error rate and a supplied component count related to the second equipment for the first period.

### Feature 3

The display method according to feature 1 or 2, in which
the second user interface is configured to display:
   a first comparison result between the error rate and a first threshold; and
   a second comparison result between the supplied component count and a second threshold.

### Feature 4

The display method according to any one of features 1 to 3, in which
the second user interface is configured to further display a component scrap rate related to the first equipment for the first period.

### Feature 5

The display method according to any one of features 1 to 4, in which
the second user interface is configured to further display a utilization ratio and a setup count related to the first equipment for the first period, and
the setup count indicates a number of lots processed by the equipment.

### Feature 6

The display method according to any one of features 1 to 5, in which
the first period is subdivided into a plurality of sub-periods, and
the second user interface includes a first chart that discriminably displays, in each of the plurality of sub-periods, time periods in which the first equipment operated, time periods in which an operation of the first equipment was not planned, and time periods in which an error of the first equipment occurred.

### Feature 7

The display method according to any one of features 1 to 6, further including:
displaying, on the screen of the terminal device, a third user interface including information related to a first lot processed by the first equipment in the first period,
the third user interface including a start time of a first processing of the first lot, an end time of the first processing, an error rate of the first processing, and a supplied component count of the first processing.

### Feature 8

The display method according to feature 7, in which
the first period is subdivided into a plurality of sub-periods, and
the third user interface includes a second chart that displays error counts of the first processing for each of the plurality of sub-periods so that the error counts are discriminable for each cause.

### Feature 9

The display method according to feature 7 or 8, in which
the first user interface is configured to accept selections of a plurality of equipment of different manufacturers,
the first equipment is manufactured by a first manufacturer,
a second equipment is manufactured by a second manufacturer, and
the third user interface is configured so that, when the first equipment and the second equipment are selected in the first user interface, the third user interface displays:
   the start time of the first processing of the first lot, the end time of the first processing, the error rate of the first processing, the supplied component count of the first processing, a start time of a second processing of a second lot processed by the second equipment in the first period, an end time of the second processing, an error rate of the second processing, and a supplied component count of the second processing.

### Feature 10

The display method according to any one of features 1 to 9, in which
the second user interface is configured to further display an icon in a portion of the second user interface on the screen of the terminal device, and
the first user interface is displayed when the icon is selected.

### Feature 11

A display method of displaying, on a screen of a terminal device, data related to equipment, the display method including:
displaying a first user interface configured to accept
   a selection of an equipment supplying components to a workpiece, and
   a selection of a period; and
displaying a third user interface including information related to a first lot processed by a first equipment selected in the first user interface for a first period selected in the first user interface;
the third user interface including a start time of a first processing of the first lot, an end time of the first processing, an error rate of the first processing, and a supplied component count of the first processing.

### Feature 12

The display method according to feature 11, in which
the first user interface is configured to accept selections of a plurality of equipment of different manufacturers,
the first equipment is manufactured by a first manufacturer,
a second equipment is manufactured by a second manufacturer,
the third user interface is configured so that, when the first equipment and the second equipment are selected in the first user interface, the third user interface displays the start time of the first processing of the first lot, the end time of the first processing, the error rate of the first processing, the supplied component count of the first processing, a start time of a second processing of a second lot processed by the second equipment in the first period, an end time of the second processing, an error rate of the second processing, and a supplied component count of the second processing.

### Feature 13

The display method according to any one of features 1 to 12, in which
the component is at least one selected from the group consisting of solder, an adhesive, and a part.

### Feature 14

The display method according to any one of features 1 to 12, in which
the components are parts,
the equipment are mounters configured to mount the parts on a board,
a first mounter is selected, and
the second user interface is configured to display a part scrap rate, an error rate, and a mounted part count related to the first mounter for the first period.

### Feature 15

A terminal device, including:
a processing circuit,
the terminal device being configured to perform the display method according to any one of features 1 to 14.

### Feature 16

A program, when executed by a terminal device, causing the terminal device to perform the display method according to any one of features 1 to 14.

### Feature 17

A storage medium storing the program according to feature 16.

According to the embodiments above, a display method, a terminal device, a program, and a storage medium are provided in which indicators of any equipment for any period can be displayed. A user can ascertain indicators of any equipment for any period based on the displayed information.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out

1. A display method of displaying, on a screen of a terminal device, data related to equipment supplying components to a workpiece, the display method comprising:
displaying a first user interface configured to accept a selection of an equipment and a selection of a period; and
displaying a second user interface including an error rate and a supplied component count related to a first equipment selected in the first user interface for a first period selected in the first user interface.

2. The display method according to claim 1, wherein
the first user interface is configured to accept selections of a plurality of equipment of different manufacturers,
the first equipment is manufactured by a first manufacturer,
a second equipment is manufactured by a second manufacturer, and
the second user interface is configured so that, when the first equipment and the second equipment are selected in the first user interface, the second user interface displays:
the error rate and the supplied component count related to the first equipment for the first period; and
an error rate and a supplied component count related to the second equipment for the first period.

3. The display method according to claim 1, wherein
the second user interface is configured to display:
a first comparison result between the error rate and a first threshold; and
a second comparison result between the supplied component count and a second threshold.

4. The display method according to claim 1, wherein
the second user interface is configured to further display a component scrap rate related to the first equipment for the first period.

5. The display method according to claim 1, wherein
the second user interface is configured to further display a utilization ratio and a setup count related to the first equipment for the first period, and
the setup count indicates a number of lots processed by the equipment.

6. The display method according to claim 1, wherein
the first period is subdivided into a plurality of sub-periods, and
the second user interface includes a first chart that discriminably displays, in each of the plurality of sub-periods, time periods in which the first equipment operated, time periods in which an operation of the first equipment was not planned, and time periods in which an error of the first equipment occurred.

7. The display method according to claim 1, further comprising:
displaying, on the screen of the terminal device, a third user interface including information related to a first lot processed by the first equipment in the first period,
the third user interface including a start time of a first processing of the first lot, an end time of the first processing, an error rate of the first processing, and a supplied component count of the first processing.

8. The display method according to claim 7, wherein
the first period is subdivided into a plurality of sub-periods, and
the third user interface includes a second chart that displays error counts of the first processing for each of the plurality of sub-periods so that the error counts are discriminable for each cause.

9. The display method according to claim 7, wherein
the first user interface is configured to accept selections of a plurality of equipment of different manufacturers,
the first equipment is manufactured by a first manufacturer,
a second equipment is manufactured by a second manufacturer, and
the third user interface is configured so that, when the first equipment and the second equipment are selected in the first user interface, the third user interface displays:
the start time of the first processing of the first lot, the end time of the first processing, the error rate of the first processing, the supplied component count of the first processing, a start time of a second processing of a second lot processed by the second equipment in the first period, an end time of the second processing, an error rate of the second processing, and a supplied component count of the second processing.

10. The display method according to claim 1, wherein
the second user interface is configured to further display an icon in a portion of the second user interface on the screen of the terminal device, and
the first user interface is displayed when the icon is selected.

11. A display method of displaying, on a screen of a terminal device, data related to equipment, the display method comprising:
displaying a first user interface configured to accept
a selection of an equipment supplying components to a workpiece, and
a selection of a period; and
displaying a third user interface including information related to a first lot processed by a first equipment selected in the first user interface for a first period selected in the first user interface;
the third user interface including a start time of a first processing of the first lot, an end time of the first processing, an error rate of the first processing, and a supplied component count of the first processing.

12. The display method according to claim 11, wherein
the first user interface is configured to accept selections of a plurality of equipment of different manufacturers,
the first equipment is manufactured by a first manufacturer,
a second equipment is manufactured by a second manufacturer,
the third user interface is configured so that, when the first equipment and the second equipment are selected in the first user interface, the third user interface displays the start time of the first processing of the first lot, the end time of the first processing, the error rate of the first processing, the supplied component count of the first processing, a start time of a second processing of a second lot processed by the second equipment in the first period, an end time of the second processing, an error rate of the second processing, and a supplied component count of the second processing.

13. The display method according to claim 1, wherein
the component is at least one selected from the group consisting of solder, an adhesive, and a part.

14. The display method according to claim 1, wherein
the components are parts,
the equipment are mounters configured to mount the parts on a board,
a first mounter is selected, and
the second user interface is configured to display a part scrap rate, an error rate, and a mounted part count related to the first mounter for the first period.

15. A terminal device, comprising:
a processing circuit,
the terminal device being configured to perform the display method according to claim 1.

16. A storage medium storing a program,
the program, when executed by a terminal device, causing the terminal device to perform the display method according to claim 1.
